(19) United States
(12) Patent Application Publication
(10) Pub. No.: US 2003/0049419 A1
(43) Pub. Date: Mar. 13, 2003

(54) Inkjet recording material having improved light fastness

(76) Inventors: Richard Anthony Barcock, Aylesbury (GB); Douglas Brownbridge, High Wycombe (GB); Aidan Joseph Lavery, Aylesbury (GB)

Correspondence Address: Craig J. Arnold, Amster, Rothstein & Ebenstein, 90 Park Avenue, New York, NY, 10016, US

(21) Appl. No.: 10/106,480

(22) Filed: Mar. 25, 2002

(30) Foreign Application Priority Data
Apr. 3, 2001 (DE) 101 16 626.5

(51) Int. Cl. B41M 5/00

(52) U.S. Cl. 428/195

(57) ABSTRACT

An ink-jet recording material, having a carrier and at least one lower layer, possibly containing pigment, and one upper layer, containing pigment, contains a mixture, which contains at least one radical inhibitor and at least one UV absorber, in the upper or lower layer in a quantitative proportion of 1:1 to 6:1 and allows, in addition to higher lightfastness, greater color range, high image resolution, high ability to absorb ink, and short drying time.

### BACKGROUND OF THE INVENTION

The present invention relates to a recording material for the ink-jet printing process having a carrier and at least one lower layer and one upper layer, which contains pigment and a mixture of a UV-absorber and a radical inhibitor.

In the ink-jet recording method, tiny ink droplets are applied onto a recording material with the aid of different techniques, which have been already described several times, and absorbed by the recording material.

Different requirements are placed on the recording material, such as high color density of the printed dots, a fast ink absorption and a sufficient wiping fastness connected therewith, a dye diffusion in the transverse direction of the printed dots which does not exceed the required degree as well as minimal mottle and a high water fastness. Further requirements, particularly for photo-like prints, are homogenous print gloss and surface gloss of the recording material.

Ink-jet printing methods have become very important in recent years. The recording films originally had a high proportion of a binding agent which swelled up in water, for example polyvinyl alcohol and gelatin. This binding agent was applied either to the base paper or to a substrate coated with polyolefin. Such materials have the advantage that they are glossy and have a very high color density after printing. This also applies for systems based on gelatin. A main disadvantage is the long drying time, so that the surface quality may be impaired during the handling of the prints.

In recent years, development has moved toward more mesoporous systems, which are able to rapidly absorb the inks during the printing due to hollows in the film applied and are particularly suitable for piezo-type printing heads. These recording materials generally contain a high proportion of pigment. The pigments have a size in the nanometer range, particularly below the wavelength of visible light, and are therefore smaller than 400 nm in order to ensure a glossy surface. These recording materials have an outstanding image quality due to the good color fixing. They have a short drying time and problems with coalescence and bleed do not occur. However, such mesoporous systems react sensitively to exposure to light and ozone. Silver salt photographs are light-fast for a period of 15 to 20 years and ink-jet images are to be light-fast for at least as long. In addition, a full color range of the printed images is of great significance. However, ink dyes which provide improved color saturation are basically susceptible to photodegradation.

Previously suggested solutions of the problem include laminating the printed image using a polyester film, using inks containing light-stable pigments, or the addition of metalliferous colorants to the inks. These solutions do have positive aspects, but they are not free of disadvantages. The disadvantages include, on one hand, increased production costs, caused by the lamination step. On the other hand, the metalliferous colorant tends to cause significant color shifts, which are noticeable as color cloudiness. To improve the lightfastness, additives such as UV absorbers or antioxidants are introduced into the coating solutions. However, the addition of the additives mentioned may simultaneously significantly impair the ability to absorb ink.

In EP 0 937 582 A, cyclodextrin is used to increase the lightfastness. In U.S. Pat. No. 5,948,150, a composition made of defined UV absorbers, radical inhibitors, and antioxidants dissolved in a solvent is applied to a carrier material together with a binding agent. An improvement of the lightfastness is only achieved in images which are printed using a specific printer type. However, the recording material described in the publication cited has an insufficient ability to absorb ink and is therefore not suitable for rapidly operating printer systems such as piezo printers.

A polymer additive having guanidine groups is used in U.S. Pat. No. 5,712,027 to improve the lightfastness.

### SUMMARY OF THE INVENTION

The present invention has the object of providing a recording material for the ink-jet printing method having a high gloss, high color density, large color range, and high image resolution, but above all a good lightfastness, particularly resistance to the effects of ozone. The recording material is further to have a short drying time and a high ability to absorb ink.

These objects are achieved by an ink-jet recording material having a carrier and at least one lower layer and an upper layer containing a pigment, with the upper layer containing a mixture which contains at least one UV absorber and at least one radical inhibitor in a quantitative proportion 1:1 to 6:1. According to an alternative embodiment, this object is also achieved by an inkjet recording material having a carrier and at least one lower layer and one upper layer containing pigment, with the lower layer containing a mixture which contains at least one UV absorber and at least one radical inhibitor in a quantitative proportion of 1:1 to 6:1.

### DETAILED DESCRIPTION OF THE PREFERRED EMBODIMENTS

Chromophore protectors such as transition metal complexes are also referred to as radical inhibitors according to the present invention. In a separate embodiment of the present invention, the mixture contains a combination of radical inhibitors. At least one component of the previously mentioned combination is a transition metal complex. Compounds such as Cu(II), Ni(II), and Co(II) acetates or acetyl acetonates are particularly well suitable. The proportion of the transition metal complex may be 10 to 60 weight-percent, preferably 20 to 50 weight-percent, in relation to the mass of the mixture according to the present invention.

In a further embodiment of the present invention, the mixture mentioned above may contain, in addition to radical inhibitors and UV absorbers, an antioxidant. Preferably, the mixture contains all three components in equal parts.

The quantity of the mixture in the upper or lower layer may be 0.1 to 10 weight-percent, in relation to the mass of the dried layer.

The radical inhibitors used in the mixture may all be organic or inorganic compounds which, when added to the coating mass, eliminate the molecules having one or more unpaired electrons which exist there. These include, for example, hindered aminoether derivatives, alkyl-substituted phenols, or transition metal complexes.

All typical organic substances which have a tendency to absorb UV radiation may be used as a UV absorber. Typical UV absorbers are, for example, substituted benzotriazoles, derivatives of benzophenone, phenyl-substituted acrylates, triphenyl triazines, or salicylates. Aryl ketones such as anthrone and 9-fluorenone, as well as 2-(2-hydroxy-3,5-di-tert-amyl-phenyl)-2H-benzotriazole have been shown to be particularly suitable.

All organic and inorganic compounds which restrict or prevent oxidation processes caused by the effect of oxygen may be used as antioxidants. Examples of these are phenols substituted by sterically hindered groups, hydroquinone, aromatic amines, organic sulfides, polysulfides, dithiocarbamates, thiols, phosphites, and phosphonates. N-phenyl-2-naphthylamine, 4-methyl-2,6-di-tert-butylphenol und 1,4-benzoquinone have been shown to be particularly suitable.

Starting from the known negative effects of the additives such as yellowing of the recording material in the event UV absorbers are used, reduction in gloss or a cracking effect in the event hindered amines are used, or clouding of the printed image in the event metal complexes are used, it was surprisingly determined that mixing of the additives in a specific quantitative range showed a synergistic effect in regard to the durability of the colors, without the disadvantages described above, and, in addition, did not impair the rapid drying of the recording material.

Surprisingly, it has been shown that the use of barium sulfate as a pigment in the lower layer amplifies the effect according to the present invention. In addition, the recording material according to the present invention may be used for both inks containing colorants and those containing pigments. In this way, universal usability for an array of different printers is provided. The ink liquid is rapidly absorbed from the lower layer by the mixture according to the present invention, supported by the arrangement of at least two layers, with the colorants or color pigments of the inks being fixed on the surface of the upper layer, i.e. their migration within the layers is prevented.

The pigment used in the upper layer has a particle size of at most approximately 500 nm, preferably up to 300 nm. The pigments include, for example, silicic acid, cationically modified silicic acid, aluminum oxide, cationically modified aluminum oxide, barium sulfate, and/or barium oxide, as well as mixtures of these. Aluminum oxide having a particle size of 50 to 180 nm and a specific surface (BET=Brunauer-Emmett-Teller) of 40 to 70 m²/g is particularly preferred. The upper layer is the layer onto which the ink liquid is applied by the printing head of the printer. The upper layer may contain a binding agent from the group of hydrophilic colloidal and/or water-soluble/water dispersible polymers. Binding agents such as polyvinyl alcohol, completely or partially saponified, cationically modified polyvinyl alcohol, polyvinyl alcohol having silyl groups, polyvinyl alcohol having acetyl groups, polyvinyl pyrollidone, polyvinyl acetate, gelatins, starches, starch derivatives such as hydroxy ethyl starch, casein, cellulose esters such as carboxymethylcellulose, polyethylene oxide, polyethylene glycol, polyacrylic acid, styrene/butadiene latex, and styrene/acrylate latex, or mixtures of these binding agents, are suitable. Polyvinyl alcohol is particularly suitable as a binding agent, with a partially-saponified polyvinyl alcohol having a high viscosity of 35 to 80 cP, particularly 40 to 60 cP (measured at 4% aqueous solution at 20° C.) being preferred. However, a completely saponified polyvinyl alcohol or acetyl-modified and silanol-modified polyvinyl alcohols may also be used.

The quantitative proportion of pigment/binder in the upper layer is 20:1 to 1:1, preferably 14:1 to 6:1, particularly, however, 8:1 to 6:1.

The application weight of the upper layer was 10 to 25 g/m², particularly 15 to 20 g/m².

According to one embodiment, the lower layer may contain 5 to 95 weight-percent pigment, particularly 50 to 95 weight-percent pigment, in relation to the mass of the dried layer.

The pigment used in the lower layer preferably has a particle size from 0.1 to 6 μm. Barium sulfate having a particle size from 0.2 to 2 μm, particularly 0.5 to 1.2 μm, is particularly preferred. In a preferred embodiment of the present invention, at least one further pigment such as aluminum oxide and/or silicic acid is included in addition to barium sulfate, with aluminum oxide obtained from aluminum hydroxide by calcinating and having a specific surface (BET) of 160 to 240 m²/g and a particle size from 0.7 to 5 μm, particularly 1 to 3 μm, having been shown to be particular suitable. The quantitative proportion of barium sulfate/aluminum oxide is preferably 3:1 to 1:3.

The lower layer may contain a hydrophilic colloidal and/or water-soluble/water-dispersible binding agent. Binding agents such as polyvinyl alcohol, completely or partially saponified, cationically modified polyvinyl alcohol, polyvinyl alcohol having silyl groups, polyvinyl alcohol having acetyl groups, polyvinyl pyrollidone, polyvinyl acetate, gelatins, starches, starch derivatives such as a hydroxyethyl starch, casein, cellulose esters such as carboxymethylcellulose, polyethylene oxide, polyethylene glycol, polyacrylic acid, styrene/butadiene latex, and styrene/acrylate latex are suitable. A completely and/or partially saponified polyvinyl alcohol or its acetyl-modified and silanol-modified derivatives are particularly suitable. In the case of the use of a pigment in the lower layer, the quantitative proportion of pigment/binder is 10:1 to 1:1, preferably 8:1 to 1:1. The amount applied may be 5 to 30 g/m², preferably 10 to 25 g/m².

The upper and lower layers may also contain further additives and supplements such as dye-fixing compounds, surfactants, softeners, wetting agents, color pigments, and optical brightening agents. The dye-fixing agents include, for example, quaternary polyammonium salts, cationic polyamines, cationic polyacrylamides, and cationic polyethylene imines. The quantity of the supplements may be up to 10 weight-percent, in relation to the mass of the dried layer.

In principle, any base paper may be used as a carrier material. Surface coated, calendered, or not calendered or strongly sized base papers are preferred. The paper may be sized acidically or neutrally. The base paper is to have a high dimensional stability and is to be capable of absorbing the liquid contained in the inks without forming waves. Papers having greater dimensional stability made of pulp mixtures of softwood pulps and eucalyptus pulps are particularly suitable. In this regard, the disclosure of DE 196 02 793 B1, which describes a base paper for an ink-jet recording material, is incorporated by reference. The base paper may contain further supplements and additives typical in the paper industry, such as dyes, optical brightening agents, or defoamers. The use of waste cellulose and reprocessed old paper is also possible.

Base papers having a surface weight of 50 to 300 g/m² may be used. Base papers having a surface roughness of <300 Sheffield units, particularly <200 Sheffield units, measured in accordance with TAPPI T538, are particularly well suitable.

Furthermore, papers which are cast-coated and dried using a heated cylinder surface are well suitable as a carrier material (cast-coated papers). The coating may contain kaolin and/or calcium carbonate as a pigment.

In addition, a paper coated on one or both sides using polyolefins, particularly using polyethylene (LDPE and/or HDPE), is suitable as a carrier material. The amount of polyethylene applied is 5 to 20 g/m². Plastic films, for example those made of polyester or polyvinyl chloride, are also suitable as a carrier. The basis weight of the carrier may be 50 to 300 g/m².

Any desired, generally known application and metering method may be used for applying the layers, such as roller application, gravure, and nipple methods and air brush or roll squeegee metering. Application with the aid of a cascade coating facility or a slot caster is particularly preferred.

The back side may be provided with a separate functional layer in the printer to adjust the curling behavior, the antistatic effect, and the transportability. Suitable backing layers are described in DE 43 08 274 A1 and DE 44 28 941 A1, whose disclosures are incorporated by reference.

The following examples are used for further explanation of the present invention.

### EXAMPLES 1 to 18

To produce the lower layer, 77.6 g of barium sulfate (70%) and 60.4 g aluminum oxide (90%) were dispersed in 206 g of water (demineralized) and mixed with 155.3 g of a 10% polyvinyl alcohol solution. The coating mass obtained for the lower layer was applied on the front of a base paper neutrally sized using alkyl ketene dimer and surface sized using starch, having a basis weight of 135 g/m², with the aid of a slot caster and dried at 100° C. The dried application weight was 15 g/m².

To produce the mass for the upper layer, 166.66 g of aluminum oxide (40%) and 55.54 g of a 12% polyvinyl alcohol solution were mixed into 44.11 g of water (demineralized) with the addition of the additives specified in tables 1 to 3 and heated to 40° C. the coating mass was stirred for 30 minutes and applied using a slot caster onto the paper previously coated with the lower layer and subsequently dried at 100° C. The dried application weight was 20 g/m².

### COMPARATIVE EXAMPLE 1 (V1)

The lower layer of comparative example 1 has the same composition as in example 1. It was applied in the same layer thickness.

The upper layer has the same composition as in examples 1 to 18, but without the addition of supplements to improve the lightfastness. It was applied in the same layer thickness.

In addition, the recording papers suggested by the printer manufacturers such as Epson PM S041287 for Epson 740, HP Premium for HP 970 cxi, Canon GP-301 and PR-101 for Canon BJC 8200, as well as the commercially available microporous recording material Konica QP as a universal standard for every printer type, were used as a comparison to determine the lightfastness.

TABLE 1

| | Compound | Mode of operation |
|---|---|---|
| A | Bis(2,2,6,6-tetramethyl-1- | Radical inhibitor |
| | (octyloxy)-4-piperi-dinyl)decane | |
| | diacidester | |
| B | Cu(II) acetate monohydrate | Radical inhibitor |
| C | Ni(II) acetate tetrahydrate | Radical inhibitor |
| D | Co(II) acetylacetonate hydrate | Radical inhibitor |
| E | 2-(2-hydroxy-3,5-di-tert-amyl- | UV absorber |
| | phenyl)-2H-benzotriazole | |
| F | anthrone | UV absorber |
| G | 9-fluorenone | Antioxidant |
| H | N-phenyl-2-naphthylamine | Antioxidant |
| I | 4-methyl-2,6-di-tert-butylphenol | Antioxidant |
| J | 1,4-benzoquinone | Antioxidant |

Tests

The recording materials obtained were tested for light-fastness, drying, color spread (bleed), mottle (coalescence), image resolution, and water resistance. It was determined that no negative effects in regard to color spread, image resolution, drying time, and coalescence resulted using the mixtures composed according to the present invention. Therefore, only the test results in regard to lightfastness are summarized in tables.

The basis of the tests are color prints from various printer types such as Epson 740 (720 dpi), Canon BJC 8200, and HP 970 cxi.

Lightfastness—the paper samples, printed with bars in the colors cyan, magenta, yellow, black, red, blue, and green, were introduced into an ATLAS 3000i Weatherometer (1.2 W/m²) for 72 hours at 30° C. and a relative ambient humidity of 60%. The evaluation of the fading of the colors was performed in accordance with the CIE L*a*b system for each color before and after the treatment previously described. The CIE L*a*b values were measured using an X-Rite Color Digital Swatchbook (X-Rite Inc., Grandville, Mich., USA). The calculation of the total color difference ÄE was performed according to the equation:

ΔE=((ΔL*)²+(Δa*)²+(Δb*)²)^{½}.

The fading of each color bar in comparison to the standard material is calculated as % ΔE in accordance with the following equation (DIN 6174) and summarized in tables 4 to 6:

% ΔE=(total ΔE/total ΔE standard)×100%.

The smaller the % ΔE value, the better the lightfastness of the material.

As is obvious from tables 4 to 6, a significant improvement of the lightfastness may be achieved for all colors by the use of the mixtures composed according to the present invention. Through the correct selection of the individual components within the quantitative range according to the present invention, the lightfastness of the particularly susceptible magenta dyes may be significantly improved.

TABLE 2
Additive mixtures in the layer

| Examples | Radical inhibitor | UV absorber | antioxidant |
|---|---|---|---|
| V1 | | | |
| 1, 2, 3 | A, B | E | |
| 4, 5, 6 | A, C | E | |
| 7, 8, 9 | A, D | E | |
| 10 | A | F | H |
| 11 | A | F | J |
| 12 | A | F | I |
| 13 | A | G | H |
| 14 | A | G | J |
| 15 | A | G | I |
| 16 | A | E | H |
| 17 | A | E | J |
| 18 | A | E | I |

TABLE 3
Concentration (%) of the additives in the layer

| | Concentration (weight-percent, dry) | | | | | | | | | |
|---|---|---|---|---|---|---|---|---|---|---|
| Ex.: | A | B | C | D | E | F | G | H | I | J |
| V1 | | | | | | | | | | |
| 1 | 1 | 0.75 | | | 0.5 | | | | | |
| 2 | 1 | 1.50 | | | 0.5 | | | | | |
| 3 | 2 | 0.75 | | | 1.0 | | | | | |
| 4 | 1 | | 0.75 | | 0.5 | | | | | |
| 5 | 1 | | 1.50 | | 0.5 | | | | | |
| 6 | 2 | | 0.75 | | 1.0 | | | | | |
| 7 | 1 | | | 0.75 | 0.5 | | | | | |
| 8 | 1 | | | 1.50 | 0.5 | | | | | |
| 9 | 2 | | | 0.75 | 1.0 | | | | | |
| 10 | 2 | | | | | 2 | | 2 | | |
| 11 | 2 | | | | | 2 | | | | 2 |
| 12 | 2 | | | | | 2 | | | 2 | |
| 13 | 2 | | | | | | 2 | 2 | | |
| 14 | 2 | | | | | | 2 | | | 2 |
| 15 | 2 | | | | | | 2 | | 2 | |
| 16 | 2 | | | | 2 | | | 2 | | |
| 17 | 2 | | | | 2 | | | | | 2 |
| 18 | 2 | | | | 2 | | | | 2 | |

TABLE 4
Printing test using Epson 740 (720 dpi)

| Example | Cyan | Magenta | Yellow | Black | Red | Blue | Green | Total ΔE | % ΔE |
|---|---|---|---|---|---|---|---|---|---|
| V1 | 8.50 | 13.22 | 8.27 | 7.40 | 9.41 | 2.14 | 10.30 | 60.23 | 100.0 |
| 1 | 4.14 | 6.73 | 2.86 | 4.61 | 6.29 | 3.87 | 1.86 | 30.36 | 50.4 |
| 2 | 6.03 | 3.80 | 3.12 | 3.79 | 1.84 | 4.68 | 1.17 | 24.43 | 40.6 |
| 3 | 5.68 | 7.33 | 2.95 | 5.75 | 5.16 | 5.37 | 1.46 | 33.69 | 55.9 |
| 4 | 4.98 | 15.33 | 2.63 | 5.77 | 15.26 | 7.64 | 2.48 | 54.09 | 89.8 |
| 5 | 5.52 | 15.30 | 2.87 | 4.21 | 14.02 | 10.22 | 2.55 | 54.69 | 90.8 |
| 6 | 4.28 | 14.07 | 2.51 | 3.77 | 15.39 | 7.94 | 3.59 | 51.55 | 85.6 |
| 7 | 4.19 | 12.95 | 3.15 | 4.98 | 12.50 | 6.43 | 2.57 | 46.77 | 77.6 |
| 8 | 5.22 | 18.54 | 1.83 | 5.43 | 17.40 | 10.62 | 2.64 | 61.68 | 102.4 |
| 9 | 4.93 | 14.41 | 1.48 | 4.84 | 13.74 | 8.70 | 1.95 | 50.06 | 83.1 |
| 10 | 4.54 | 8.26 | 3.35 | 5.54 | 7.81 | 5.64 | 2.29 | 37.43 | 62.1 |
| 11 | 5.23 | 9.63 | 1.57 | 4.80 | 8.74 | 6.86 | 3.71 | 40.53 | 667.3 |
| 12 | 4.76 | 10.14 | 3.95 | 3.61 | 9.56 | 5.24 | 3.76 | 41.01 | 68.1 |
| 13 | 5.08 | 10.28 | 16.78 | 5.12 | 11.49 | 5.15 | 4.92 | 58.82 | 97.7 |
| 14 | 2.97 | 9.47 | 3.59 | 5.08 | 8.72 | 5.80 | 2.14 | 37.77 | 62.7 |
| 15 | 5.10 | 11.05 | 2.96 | 5.26 | 13.43 | 9.11 | 5.41 | 52.32 | 886.9 |
| 16 | 5.73 | 13.68 | 1.41 | 6.14 | 12.51 | 7.26 | 1.74 | 48.47 | 80.4 |
| 17 | 4.39 | 8.61 | 4.49 | 5.50 | 5.78 | 5.25 | 1.43 | 35.45 | 58.9 |
| 18 | 4.54 | 14.98 | 3.13 | 5.78 | 14.62 | 9.20 | 3.36 | 55.61 | 92.3 |
| Epson PM | 2.67 | 11.89 | 1.17 | 2.15 | 4.35 | 5.22 | 10.69 | 38.14 | 63.3 |
| S041287 | | | | | | | | | |
| Konica QP | 8.72 | 30.16 | 5.77 | 1.58 | 10.96 | 8.93 | 15.65 | 81.77 | 135.7 |

TABLE 5
Printing test using Canon 8200

| Example | Cyan | Magenta | Yellow | Black | Red | Blue | Green | Total ΔE | % ΔE |
|---|---|---|---|---|---|---|---|---|---|
| V1 | 13.60 | 32.60 | 8.76 | 8.89 | 34.91 | 23.42 | 7.01 | 129.19 | 100.0 |
| 1 | 11.70 | 12.11 | 6.03 | 5.87 | 10.72 | 17.49 | 5.65 | 69.57 | 53.8 |
| 2 | 11.50 | 11.75 | 4.30 | 4.85 | 7.33 | 17.70 | 4.92 | 62.35 | 48.2 |
| 3 | 12.78 | 11.73 | 5.09 | 4.48 | 17.71 | 18.05 | 4.92 | 74.76 | 57.8 |
| 4 | 14.78 | 21.04 | 8.76 | 9.69 | 23.28 | 18.71 | 5.70 | 101.96 | 78.9 |
| 5 | 14.24 | 23.11 | 7.60 | 9.15 | 25.98 | 17.72 | 5.33 | 103.13 | 79.8 |
| 6 | 14.01 | 23.02 | 7.88 | 8.08 | 19.71 | 17.80 | 4.88 | 95.38 | 73.8 |
| 7 | 15.54 | 25.83 | 8.27 | 10.15 | 26.82 | 19.04 | 5.93 | 111.58 | 86.3 |
| 8 | 10.67 | 16.08 | 6.79 | 7.17 | 23.39 | 17.86 | 4.93 | 86.89 | 67.2 |
| 9 | 13.02 | 20.56 | 7.83 | 7.23 | 27.12 | 17.08 | 5.44 | 98.28 | 76.0 |
| 10 | 12.29 | 16.99 | 7.78 | 10.09 | 18.98 | 15.55 | 4.58 | 86.26 | 66.7 |
| 11 | 14.17 | 18.51 | 7.67 | 8.54 | 18.02 | 17.71 | 5.97 | 90.59 | 70.1 |
| 12 | 14.17 | 19.50 | 5.96 | 8.51 | 19.18 | 18.14 | 3.84 | 89.30 | 69.1 |
| 13 | 15.35 | 24.04 | 5.08 | 7.92 | 24.70 | 19.78 | 2.07 | 98.94 | 76.5 |
| 14 | 10.66 | 19.70 | 7.95 | 8.87 | 23.40 | 20.39 | 4.93 | 95.90 | 74.2 |
| 15 | 13.23 | 15.34 | 7.70 | 5.30 | 21.47 | 15.33 | 5.94 | 84.31 | 65.2 |
| 16 | 13.05 | 27.74 | 7.97 | 9.36 | 34.58 | 23.01 | 5.18 | 120.89 | 93.5 |
| 17 | 12.72 | 16.20 | 8.48 | 8.57 | 19.09 | 16.25 | 5.44 | 86.75 | 67.1 |
| 18 | 13.89 | 22.95 | 9.21 | 8.68 | 24.09 | 17.70 | 7.12 | 103.64 | 80.2 |
| GP-301 | 12.58 | 82.60 | 8.69 | 22.88 | 52.02 | 35.07 | 4.35 | 218.19 | 168.9 |
| PR-101 | 9.09 | 36.86 | 3.43 | 10.93 | 16.39 | 48.19 | 5.15 | 130.04 | 100.6 |
| Konica | 13.59 | 96.12 | 4.02 | 11.25 | 62.17 | 36.53 | 3.29 | 226.97 | 175.7 |
| QP | | | | | | | | | |

TABLE 6
Printing test using HP970cxi

| Example | Cyan | Magenta | Yellow | Black | Red | Blue | Green | Total ΔE | % ΔE |
|---|---|---|---|---|---|---|---|---|---|
| V1 | 11.83 | 14.06 | 2.58 | 11.35 | 18.78 | 23.99 | 14.94 | 97.53 | 100.0 |
| 1 | 8.11 | 11.70 | 3.53 | 15.23 | 12.98 | 20.73 | 3.52 | 75.80 | 77.7 |
| 2 | 10.20 | 11.22 | 4.31 | 12.76 | 13.24 | 20.43 | 3.30 | 75.46 | 77.4 |
| 3 | 9.10 | 11.03 | 2.88 | 17.85 | 12.50 | 22.11 | 3.63 | 79.10 | 81.1 |
| 4 | 8.41 | 8.02 | 3.31 | 9.84 | 5.43 | 18.87 | 3.61 | 57.49 | 58.9 |
| 5 | 9.11 | 9.62 | 2.92 | 10.49 | 5.85 | 20.66 | 4.06 | 62.71 | 64.2 |
| 6 | 8.06 | 8.80 | 2.10 | 10.46 | 6.35 | 20.59 | 3.37 | 59.73 | 61.2 |
| 7 | 9.87 | 9.17 | 3.51 | 12.46 | 6.86 | 21.97 | 4.90 | 67.84 | 70.4 |
| 8 | 7.57 | 9.65 | 2.04 | 10.80 | 5.74 | 19.46 | 5.23 | 60.49 | 62.0 |
| 9 | 7.62 | 7.70 | 3.63 | 12.45 | 5.66 | 17.67 | 3.50 | 58.23 | 59.7 |
| 10 | 13.72 | 15.82 | 7.68 | 6.34 | 10.00 | 17.08 | 11.12 | 81.76 | 83.8 |
| 11 | 8.39 | 8.50 | 2.63 | 7.11 | 5.00 | 13.34 | 5.36 | 50.33 | 51.6 |
| 12 | 10.92 | 7.98 | 0.57 | 10.06 | 6.01 | 16.42 | 6.03 | 57.99 | 59.4 |
| 13 | 9.81 | 13.55 | 2.72 | 7.18 | 10.33 | 16.61 | 9.92 | 70.12 | 71.9 |
| 14 | 7.29 | 8.35 | 4.10 | 10.41 | 5.64 | 15.69 | 4.09 | 55.57 | 57.0 |
| 15 | 8.62 | 7.69 | 1.32 | 10.83 | 5.96 | 16.40 | 4.84 | 55.66 | 57.1 |
| 16 | 9.89 | 9.52 | 2.50 | 10.02 | 7.66 | 18.32 | 5.91 | 63.82 | 65.4 |
| 17 | 15.55 | 16.71 | 7.67 | 7.41 | 9.42 | 16.65 | 11.03 | 75.22 | 77.1 |
| 18 | 8.93 | 9.25 | 2.33 | 11.13 | 9.04 | 18.36 | 6.54 | 65.58 | 67.2 |
| HP | 13.08 | 6.23 | 4.25 | 33.68 | 17.73 | 44.64 | 17.54 | 137.15 | 140.6 |
| Premium C6 | | | | | | | | | |
| 040A | | | | | | | | | |
| Konica | 20.54 | 7.94 | 3.19 | 10.56 | 15.03 | 33.23 | 23.50 | 113.99 | 116.9 |
| QP | | | | | | | | | |

We claim:

1. An ink-jet recording material having a carrier and at least one lower layer and one upper layer, which contains pigment, said upper layer comprising a mixture, which contains at least one radical inhibitor and at least one UV absorber, in a quantitative proportion of 1:1 to 6:1.

2. An ink-jet recording material having a carrier and at least one lower layer and one upper layer, which contains pigment, said lower layer comprising a mixture, which contains at least one radical inhibitor and at least one UV absorber, in a quantitative proportion of 1:1 to 6:1.

3. The recording material according to claim 1, wherein the lower layer contains pigment in a quantity of 5 to 95 weight-percent, in relation to the mass of the dried layer.

4. The recording material according to claim 2, wherein the lower layer contains pigment in a quantity of 5 to 95 weight-percent, in relation to the mass of the dried layer.

5. The recording material according to claim 3, wherein the lower layer contains pigment in a quantity of 50 to 95 weight-percent, in relation to the mass of the layer.

6. The recording material according to claim 4, wherein the lower layer contains pigment in a quantity of 50 to 95 weight-percent, in relation to the mass of the layer.

7. The recording material according to claim 1, wherein at least one radical inhibitor is a transition metal complex.

8. The recording material according to claim 2, wherein at least one radical inhibitor is a transition metal complex.

9. The recording material according to claim 7, wherein the quantity of the transition metal complex is 10 to 60 weight-percent, in relation to the mass of the mixture.

10. The recording material according to claim 8, wherein the quantity of the transition metal complex is 10 to 60 weight-percent, in relation to the mass of the mixture.

11. The recording material according to claim 9, wherein the proportion of the transition metal complex in the mixture is 20 to 50 weight-percent, in relation to the mass of the mixture.

12. The recording material according to claim 10, wherein the proportion of the transition metal complex in the mixture is 20 to 50 weight-percent, in relation to the mass of the mixture.

13. The recording material according to claim 1, wherein the mixture contains an antioxidant.

14. The recording material according to claim 2, wherein the mixture contains an antioxidant.

15. The recording material according to claim 13, wherein the mixture contains the radical inhibitor, an UV absorber, and the antioxidant in approximately equal parts.

16. The recording material according to claim 14, wherein the mixture contains the radical inhibitor, an UV absorber, and the antioxidant in approximately equal parts.

17. The recording material according to claim 1, wherein the quantity of the mixture in the layer is 0.1 to 10 weight-percent, in relation to the mass of the dried layer.

18. The recording material according to claim 2, wherein the quantity of the mixture in the layer is 0.1 to 10 weight-percent, in relation to the mass of the dried layer.

19. The recording material according to claim 1, wherein the quantity of the pigment in the upper layer is 50 to 90 weight-percent, in relation to the mass of the dried layer.

20. The recording material according to claim 2 wherein the quantity of the pigment in the upper layer is 50 to 90 weight-percent, in relation to the mass of the dried layer.

21. The recording material according to claim 1, wherein the upper layer contains aluminum oxide.

22. The recording material according to claim 2, wherein the upper layer contains aluminum oxide.

23. The recording material according to claim 1, wherein the lower layer contains at least barium sulfate as a pigment.

24. The recording material according to claim 2, wherein the lower layer contains at least barium sulfate as a pigment.

25. The recording material to claim 23, wherein the quantity of barium sulfate in the lower layer is 50 to 80 weight-percent, in relation to the mass of the total quantity of pigment in the layer.

26. The recording material to claim 24, wherein the quantity of barium sulfate in the lower layer is 50 to 80 weight-percent, in relation to the mass of the total quantity of pigment in the layer.

27. The recording material according to claim 23, wherein the lower layer contains at least one further pigment having a particle size from 0.7 to 5 μm.

28. The recording material according to claim 24, wherein the lower layer contains at least one further pigment having a particle size from 0.7 to 5 μm.

29. The recording material according to claim 1, wherein the carrier is a coated or uncoated paper.

30. The recording material according to claim 2, wherein the carrier is a coated or uncoated paper.

31. The recording material according to claim 29, wherein the carrier is a paper coated on the back side with polyethylene.

32. The recording material according to claim 30, wherein the carrier is a paper coated on the back side with polyethylene.
